(19) United States
(12) Patent Application Publication
(10) Pub. No.: US 2025/0178836 A1
(43) Pub. Date: Jun. 5, 2025

(54) A BUFFER SYSTEM FOR TEMPORARILY STORING CONTAINERS IN AN AUTOMATED STORAGE AND RETRIEVAL SYSTEM

(71) Applicant: AutoStore Technology AS, Nedre Vats (NO)

(72) Inventor: Jørgen Djuve Heggebø, Langhus (NO)

(21) Appl. No.: 18/875,796

(22) PCT Filed: Sep. 19, 2023
(86) PCT No.: PCT/EP2023/075757

§ 371 Date: Dec. 17, 2024

(30) Foreign Application Priority Data
Sep. 29, 2022 (NO) 20221034

(51) Int. Cl. B65G 1/137; B65G 1/04

(52) U.S. Cl. CPC B65G 1/137; B65G 1/0464

(57) ABSTRACT

The present invention relates to a buffer system (10) for temporarily storing containers (106) in an automated storage and retrieval system (1). The buffer system (10) comprises an endless guide (13, 14) and a plurality of container carriers (20) connected to the endless guide (13, 14). The plurality of container carriers (20) are individually movable along the endless guide (13, 14) between a container handling position (HP), in which a container (106) is loaded onto and/or unloaded from one of the container carriers (20), and buffering positions (BP), in which the containers (106) are temporarily stored on their respective container carrier (20). The invention also relates to an access station and a system with such a buffer system.

### FIELD OF THE INVENTION

The present invention relates to a buffer system for temporarily storing containers in an automated storage and retrieval system. The present invention also relates to an access station for presentation of a storage container from an automated storage and retrieval system to an operator at the access station. The present invention also relates to an automated storage and retrieval system comprising a framework structure. The present invention also relates to a method for temporarily storing containers in an automated storage and retrieval system.

### BACKGROUND AND PRIOR ART

FIG. 1 discloses a prior art automated storage and retrieval system 1 with a framework structure 100 and FIGS. 2, 3 and 4 disclose three different prior art container handling vehicles 201,301,401 suitable for operating on such a system 1.

The framework structure 100 comprises upright members 102 and a storage volume comprising storage columns 105 arranged in rows between the upright members 102. In these storage columns 105 storage containers 106, also known as bins, are stacked one on top of one another to form stacks 107. The members 102 may typically be made of metal, e.g. extruded aluminum profiles.

The framework structure 100 of the automated storage and retrieval system 1 comprises a rail system 108 arranged across the top of framework structure 100, on which rail system 108 a plurality of container handling vehicles 201,301,401 may be operated to raise storage containers 106 from, and lower storage containers 106 into, the storage columns 105, and also to transport the storage containers 106 above the storage columns 105. The rail system 108 comprises a first set of parallel rails 110 arranged to guide movement of the container handling vehicles 201,301,401 in a first direction X across the top of the frame structure 100, and a second set of parallel rails 111 arranged perpendicular to the first set of rails 110 to guide movement of the container handling vehicles 201,301,401 in a second direction Y which is perpendicular to the first direction X. Containers 106 stored in the columns 105 are accessed by the container handling vehicles 201,301,401 through access openings 112 in the rail system 108. The container handling vehicles 201,301,401 can move laterally above the storage columns 105, i.e. in a plane which is parallel to the horizontal X-Y plane.

The upright members 102 of the framework structure 100 may be used to guide the storage containers during raising of the containers out from and lowering of the containers into the columns 105. The stacks 107 of containers 106 are typically self-supporting.

Each prior art container handling vehicle 201,301,401 comprises a vehicle body 201a,301a,401a and first and second sets of wheels 201b, 201c, 301b, 301c,401b,401c which enable the lateral movement of the container handling vehicles 201,301,401 in the X direction and in the Y direction, respectively. In FIGS. 2, 3 and 4 two wheels in each set are fully visible. The first set of wheels 201b,301b,401b is arranged to engage with two adjacent rails of the first set 110 of rails, and the second set of wheels 201c,301c,401c is arranged to engage with two adjacent rails of the second set 111 of rails. At least one of the sets of wheels 201b, 201c, 301b,301c,401b,401c can be lifted and lowered, so that the first set of wheels 201b,301b,401b and/or the second set of wheels 201c,301c,401c can be engaged with the respective set of rails 110, 111 at any one time.

Each prior art container handling vehicle 201,301,401 also comprises a lifting device for vertical transportation of storage containers 106, e.g. raising a storage container 106 from, and lowering a storage container 106 into, a storage column 105. The lifting device comprises one or more gripping/engaging devices which are adapted to engage a storage container 106, and which gripping/engaging devices can be lowered from the vehicle 201,301,401 so that the position of the gripping/engaging devices with respect to the vehicle 201,301,401 can be adjusted in a third direction Z which is orthogonal the first direction X and the second direction Y. Parts of the gripping device of the container handling vehicles 301,401 are shown in FIGS. 3 and 4 indicated with reference number 304,404. The gripping device of the container handling device 201 is located within the vehicle body 201a in FIG. 2 and is thus not shown.

Conventionally, and also for the purpose of this application, Z=1 identifies the uppermost layer available for storage containers below the rails 110,111, i.e. the layer immediately below the rail system 108, Z=2 the second layer below the rail system 108, Z=3 the third layer etc. In the exemplary prior art disclosed in FIG. 1, Z=8 identifies the lowermost, bottom layer of storage containers. Similarly, X=1 . . . n and Y=1 . . . n identifies the position of each storage column 105 in the horizontal plane. Consequently, as an example, and using the Cartesian coordinate system X, Y, Z indicated in FIG. 1, the storage container identified as 106′ in FIG. 1 can be said to occupy storage position X=17, Y=1, Z=6. The container handling vehicles 201,301,401 can be said to travel in layer Z=0, and each storage column 105 can be identified by its X and Y coordinates. Thus, the storage containers shown in FIG. 1 extending above the rail system 108 are also said to be arranged in layer Z=0.

The storage volume of the framework structure 100 has often been referred to as a grid 104, where the possible storage positions within this grid are referred to as storage cells. Each storage column may be identified by a position in an X- and Y-direction, while each storage cell may be identified by a container number in the X-, Y- and Z-direction.

Each prior art container handling vehicle 201,301,401 comprises a storage compartment or space for receiving and stowing a storage container 106 when transporting the storage container 106 across the rail system 108. The storage space may comprise a cavity arranged internally within the vehicle body 201a,401a as shown in FIGS. 2 and 4 and as described in e.g. WO2015/193278A1 and WO2019/206487A1, the contents of which are incorporated herein by reference.

FIG. 3 shows an alternative configuration of a container handling vehicle 301 with a cantilever construction. Such a vehicle is described in detail in e.g. NO317366, the contents of which are also incorporated herein by reference.

The cavity container handling vehicle 201 shown in FIG. 2 may have a footprint that covers an area with dimensions in the X and Y directions which is generally equal to the lateral extent of a storage column 105, e.g. as is described in WO2015/193278A1, the contents of which are incorporated herein by reference. The term ‘lateral’ used herein may mean ‘horizontal’.

Alternatively, the cavity container handling vehicles 401 may have a footprint which is larger than the lateral area defined by a storage column 105 as shown in FIGS. 1 and 4, e.g. as is disclosed in WO2014/090684A1 or WO2019/206487A1.

The rail system 108 typically comprises rails with grooves in which the wheels of the vehicles run. Alternatively, the rails may comprise upwardly protruding elements, where the wheels of the vehicles comprise flanges to prevent derailing. These grooves and upwardly protruding elements are collectively known as tracks. Each rail may comprise one track, or each rail 110,111 may comprise two parallel tracks. In other rail systems 108, each rail in one direction (e.g. an X direction) may comprise one track and each rail in the other, perpendicular direction (e.g. a Y direction) may comprise two tracks. Each rail 110,111 may also comprise two track members that are fastened together, each track member providing one of a pair of tracks provided by each rail.

WO2018/146304A1, the contents of which are incorporated herein by reference, illustrates a typical configuration of rail system 108 comprising rails and parallel tracks in both X and Y directions.

In the framework structure 100, a majority of the columns 105 are storage columns 105, i.e. columns 105 where storage containers 106 are stored in stacks 107. However, some columns 105 may have other purposes. In FIG. 1, columns 119 and 120 are such special-purpose columns used by the container handling vehicles 201,301,401 to drop off and/or pick up storage containers 106 so that they can be transported to an access station (not shown) where the storage containers 106 can be accessed from outside of the framework structure 100 or transferred out of or into the framework structure 100. Within the art, such a location is normally referred to as a ‘port’ and the column in which the port is located may be referred to as a ‘port column’ 119,120. The transportation to the access station may be in any direction, that is horizontal, tilted and/or vertical. For example, the storage containers 106 may be placed in a random or dedicated column 105 within the framework structure 100, then picked up by any container handling vehicle and transported to a port column 119,120 for further transportation to an access station. The transportation from the port to the access station may require movement along various different directions, by means such as delivery vehicles, trolleys or other transportation lines. Note that the term ‘tilted’ means transportation of storage containers 106 having a general transportation orientation somewhere between horizontal and vertical.

In FIG. 1, the first port column 119 may for example be a dedicated drop-off port column where the container handling vehicles 201,301,401 can drop off storage containers 106 to be transported to an access or a transfer station, and the second port column 120 may be a dedicated pick-up port column where the container handling vehicles 201,301,401 can pick up storage containers 106 that have been transported from an access or a transfer station.

The access station may typically be a picking or a stocking station where product items are removed from or positioned into the storage containers 106. In a picking or a stocking station, the storage containers 106 are normally not removed from the automated storage and retrieval system 1, but are returned into the framework structure 100 again once accessed. A port can also be used for transferring storage containers to another storage facility (e.g. to another framework structure or to another automated storage and retrieval system), to a transport vehicle (e.g. a train or a lorry), or to a production facility.

A conveyor system comprising conveyors is normally employed to transport the storage containers between the port columns 119,120 and the access station.

If the port columns 119,120 and the access station are located at different levels, the conveyor system may comprise a lift device with a vertical component for transporting the storage containers 106 vertically between the port column 119,120 and the access station.

The conveyor system may be arranged to transfer storage containers 106 between different framework structures, e.g. as is described in WO2014/075937A1, the contents of which are incorporated herein by reference.

When a storage container 106 stored in one of the columns 105 disclosed in FIG. 1 is to be accessed, one of the container handling vehicles 201,301,401 is instructed to retrieve the target storage container 106 from its position and transport it to the drop-off port column 119. This operation involves moving the container handling vehicle 201,301,401 to a location above the storage column 105 in which the target storage container 106 is positioned, retrieving the storage container 106 from the storage column 105 using the container handling vehicle's 201,301,401 lifting device (not shown), and transporting the storage container 106 to the drop-off port column 119. If the target storage container 106 is located deep within a stack 107, i.e. with one or a plurality of other storage containers 106 positioned above the target storage container 106, the operation also involves temporarily moving the above-positioned storage containers prior to lifting the target storage container 106 from the storage column 105. This step, which is sometimes referred to as “digging” within the art, may be performed with the same container handling vehicle that is subsequently used for transporting the target storage container to the drop-off port column 119, or with one or a plurality of other cooperating container handling vehicles. Alternatively, or in addition, the automated storage and retrieval system 1 may have container handling vehicles 201,301,401 specifically dedicated to the task of temporarily removing storage containers 106 from a storage column 105. Once the target storage container 106 has been removed from the storage column 105, the temporarily removed storage containers 106 can be repositioned into the original storage column 105. However, the removed storage containers 106 may alternatively be relocated to other storage columns 105.

When a storage container 106 is to be stored in one of the columns 105, one of the container handling vehicles 201,301,401 is instructed to pick up the storage container 106 from the pick-up port column 120 and transport it to a location above the storage column 105 where it is to be stored. After any storage containers 106 positioned at or above the target position within the stack 107 have been removed, the container handling vehicle 201,301,401 positions the storage container 106 at the desired position. The removed storage containers 106 may then be lowered back into the storage column 105, or relocated to other storage columns 105.

For monitoring and controlling the automated storage and retrieval system 1, e.g. monitoring and controlling the location of respective storage containers 106 within the framework structure 100, the content of each storage container 106, and the movement of the container handling vehicles 201,301,401 so that a desired storage container 106 can be delivered to the desired location at the desired time without the container handling vehicles 201,301,401 colliding with each other, the automated storage and retrieval system 1 comprises a control system 500 which typically is computerized and which typically comprises a database for keeping track of the storage containers 106.

WO 2017121515 describes a method and system for storing and transporting a plurality of storage bins to and from an upper and a lower location of a three dimensional storage grid, which is constructed by columns interconnected by top rails. The system comprises a movable continuous chain running from the upper location to the lower location of said storage grid. The chain comprises compartments fitted for holding the bins. Robot vehicles are running on the upper location of the storage grid. These are adapted for loading and unloading bins from the compartments in the chain. A control system is adapted for controlling loading and unloading of the bins from the compartments in the chain.

WO 2019001816 describes an automated storage and retrieval system comprising a three-dimensional grid with a plurality of storage columns for storing containers, one or more container handling vehicles operating on the grid for retrieving storage containers from and storing storage containers in the storage columns, and for transporting the storage containers horizontally across the grid, and an elevator for transporting containers between different temperature zones arranged horizontally relative to the storage grid, and where the temperature zones are divided by a thermal barrier.

A problem associated with known automated storage and retrieval systems is that the area surrounding the pick-up and drop-off ports may become congested with container handling vehicles instructed to drop off or pick up storage containers. In small systems this situation may possibly be alleviated by adding ports to the grid, as this will allow the container handling vehicles to be distributed among a larger number of ports in order to avoid congestion. However, if ports are added, the conveyor system infrastructure must normally be increased. This requires space, may not necessarily be available. Another problem with prior art automated storage and retrieval systems is that the separate drop-off ports and pick-up ports require the container handling vehicles to move to a storage column after drop-off to retrieve a new storage container. Likewise, the container handling vehicles have to be empty of a storage container when they are sent to a pick-up port to pick up a storage container. This results in an inefficiency and causes increased congestion around the ports, as container handling vehicles are moving around on the grid without a storage container as payload.

WO 2019/20697 describes a solution to the above problems, where the automated storage and retrieval system comprising at least one relay module for relaying storage containers between a port column and an access station, the relay module being arranged below a port column, wherein the relay module comprises a port station for receiving storage containers dropped off from and to be picked up through the port column, a first conveyor and a second conveyor, each arranged at a side of the port station, the first conveyor being adapted to transport storage containers to an access station, the second conveyor being adapted for transporting storage containers from the access station. A lateral displacement device is arranged for transporting storage containers between the port station and the first conveyor, and between the second conveyor and the port station. The invention furthermore relates to such relay module and to a method of operating an automated storage and retrieval system comprising such a relay module.

One object of the present invention is to provide a buffer within the framework structure wherein storage containers temporarily stored in the buffer can be accessed faster than by retrieving one container at the time from a stack of containers.

Another object is to provide an effective access station and to reduce congestion of container handling vehicles near the access station. Hence, one object of the present invention is to provide an alternative access station to the one described in WO 2019/206971. More specifically, one object is to reduce the footprint of the access station.

### SUMMARY OF THE INVENTION

The present invention relates to a buffer system for temporarily storing containers in an automated storage and retrieval system, wherein the buffer system comprises:
an endless guide;
a plurality of container carriers connected to the endless guide, wherein the plurality of container carriers are individually movable along the endless guide between a container handling position, in which a container is loaded onto and/or unloaded from one of the container carriers, and buffering positions, in which the containers are temporarily stored on their respective container carrier.

In one aspect, the plurality of container carriers is sequentially movable along the endless guide.

In one aspect, the endless guide is oriented in a vertical plane.

In one aspect, the endless guide comprises a first guide member and a second guide member spaced apart from the first guide member, wherein the plurality of container carriers is connected between the first guide member and the second guide member.

In one aspect, the first guide member and the second guide member are parallel to each other. In one aspect, the first guide member and the second guide member are oriented in the vertical plane. In one aspect, the first guide member and the second guide member define a path for the movement of the container carriers. In one aspect, the first guide member and the second guide member are aligned with each other.

In one aspect, the first guide member and the second guide member have a T-shaped or H-shaped cross-sectional profile. In one aspect, the endless guide is rectangular with rounded corners or O-shaped. In one aspect, the first guide member and the second guide member are rectangular with rounded corners or O-shaped.

In one aspect, the plurality of container carriers is individually movable along the endless guide between the container handling position and the buffering positions in one direction only. Alternatively, the plurality of container carriers is individually movable along the endless guide between the container handling position and the buffering positions in both directions. Hence, the container carriers may move in a first direction and in a second direction opposite of the first direction.

As the plurality of container carriers are connected to the endless guide, the sequence of arrival of the plurality of container carriers at the container handling position is predetermined, based on their connection to the endless guide relative to other container carriers, and based on their movement direction.

As used herein, the term “individually movable” is used to denote that the movement of each container carrier may be controlled individually. Hence, in case the container carriers are allowed to move in the first direction only, then at least one of the container carriers can be controlled to stay stationary while at least one of the other container carriers can be controlled to move in the first direction during the same period of time. Alternatively, in case the container carriers are allowed to move in the first direction and in the second direction, then at least one of the container carriers can be controlled to stay stationary while at least one of the other container carriers can be controlled to move in the first direction or to move in the second direction during the same period of time.

In one aspect, each of the plurality of container carriers comprises:
a main body comprising a supporting surface for supporting a storage container;
a powered wheel for moving the main body along the endless guide;
an orientation device for orienting the supporting surface during the movement of the container carrier along the endless guide.

In one aspect, each of the plurality of container carriers comprises a carrier control system for controlling the orientation device and the powered wheel.

In one aspect, each of the plurality of container carriers comprises a runner for connecting the main body to the endless guide.

Alternatively, the powered wheel is used also for the purpose of connecting the main body to the endless guide.

In one aspect, each of the plurality of container carriers comprises a first runner for connecting the main body to the first guide member and a second runner for connecting the main body to the second guide member.

In one aspect, each of the plurality of container carriers comprises a first powered wheel for moving the main body along the first guide member. Each of the plurality of container carriers may comprise a second powered or non-powered wheel for moving the main body along the second guide member. Hence, one-wheel drive container carriers or two-wheel drive container carriers are possible. Of course, it is also possible to provide the container carriers with more than two wheels.

In one aspect, the endless guide comprises an electrical contact; wherein the runner comprises an electrical pickup provided in electrical contact with the electrical contact, wherein the powered wheels and/or the orientation device are supplied with electrical power via the electrical pickup and the electrical contact.

Alternatively, the container carriers may comprise a supercapacitor or rechargeable battery, which are charged at specific positions along the endless guide.

In one aspect, the carrier control system of each container carrier is configured to control its associated orientation device to keep the supporting surface in a horizontal orientation during movement of the container carrier around the endless guide.

In one aspect, the orientation device is a servo motor controlled by the carrier control system.

In one aspect, the carrier control system comprises a sensor for sensing the orientation of the supporting surface.

In one aspect, each of the plurality of container carriers comprises:
an axle extending between a first runner and a second runner, wherein the supporting surface is arranged to pivot around the axle by means of the orientation device.

In one aspect, the main body comprises a base on which the supporting surface is secured; wherein the axle is extending through an opening provided in the base.

In one aspect, the orientation device is secured to the base. Here, the orientation device is orienting the base, and hence the supporting surface, with respect to the axle during its movement along the endless guide.

In one aspect, the supporting surface comprises pegs for preventing horizontal movement of the storage container relative to the supporting surface.

In one aspect, the pegs are corner pegs protruding upwardly from corners of the supporting surface. In one aspect, the pegs are received in a recess or cut-out in the downwardly facing surface of the storage container. Preferably, the pegs ensure that the footprint of the supporting surface is be equal to the footprint of the storage container.

In one aspect, the buffer system has a width being less than or equal to a width of a storage row of the automated storage and retrieval system.

In one aspect, the width of a storage row is here defined the distance between the centre axis of two adjacent upright members 102.

In one aspect, the powered wheel is located at least partially below the supporting surface.

In one aspect, the powered wheel is engaging a surface of the endless guide. In one aspect, the surface of the endless guide engaged by the powered wheel is a smooth surface.

In one aspect, the orientation device is allowing 360° degrees of movement of the supporting surface relative to the runner.

In one aspect, the carrier control system is configured to control the movement of the container carriers at different times and/or at different speeds.

In one aspect, the buffer system comprises:
a control system provided in communication with the carrier control systems of the respective container carriers, wherein the control system is configured to prevent collision between the container carriers.

In one aspect, the control system is a control system of the automated storage and retrieval system. Alternatively, the control system is a separate control system provided in communication with the control system of the automated storage and retrieval system.

In one aspect, the carrier control system comprises a sensor for measuring a parameter representative of the position of the container carrier. Alternatively, the buffer system comprises one or more sensors for measuring positions for the respective container carriers. The parameter representative of the position of the container carrier may be a position relative to the endless guide. The parameter representative of the position of the container carrier may be a distance between the container carrier and its preceding container carrier and/or a distance between the container carrier and its succeeding container carrier.

In one aspect, the carrier control system may control the distance between an empty container carrier to be closer to an adjacent container carrier than an occupied container carrier. Hence, the distance between empty container carriers may be shorter, reducing the time of moving such empty container carriers to the container handling position.

In one aspect, the carrier control system of the respective container carriers is configured to prevent collision with other container carriers during their movement along the endless guide.

In one aspect, the carrier control system is configured to stop the movement of the container carrier at the container handling position while moving other container carriers along the endless guide.

In one aspect, the carrier control system is configured to stop the movement of the container carrier at the container handling position only if predetermined conditions are met.

In one aspect, the buffer system is temporarily storing a container within a framework structure of the automated storage and retrieval system.

The present invention also relates to a an access station for presentation of a storage container from an automated storage and retrieval system to an operator at the access station, wherein the access station comprises:
a buffer system according to any one of the preceding claims;
   wherein the plurality of container carriers are individually movable along the endless guide to a presentation position, in which one of the storage containers stored on its respective container carrier is presented to the operator.

In one aspect, the operator is a person. Alternatively, the operator is a robot.

In one aspect, the endless guide is substantially L-shaped, wherein the container handling position is located in an upper part of a vertical projection of the L-shaped endless guide and the presentation position is located along a horizontal projection of the L-shaped endless guide.

Hence, the access station is able to collect a container from a grid opening amongst the storage columns on top of the framework structure and present it for access at a position beyond the storage columns.

In one aspect, the carrier control system of each container carrier is configured to control its associated orientation device to keep the supporting surface in an inclined orientation relative to the horizontal plane in the presentation position.

In one aspect, the supporting surface has an inclination of 15°-45° relative to the horizontal plane when in the inclined orientation in the presentation position.

In one aspect, the endless guide comprises a first guide member and a second guide member, wherein a section of the first guide member is located at a first height, wherein a section of the second guide member is located at a second height, wherein the container carriers moving along the sections are in their presentation position and wherein the first height is larger than the second height.

According to the above, it is achieved that the supporting surface, and hence the storage container supported on the supporting surface, becomes inclined with an angle of 15°-45° with respect to the horizontal plane.

In one aspect, the access station comprises more than one presentation position.

Hence, picking may be performed from more than one storage container and replenishment may be performed to more than one storage container at the same time.

The present invention also relates to a an automated storage and retrieval system comprising a framework structure, wherein the framework structure comprises:
upright members;
a storage volume comprising storage columns provided between the upright members, wherein storage containers are stackable in stacks within the storage columns;
a rail system provided on top of the upright members;
   wherein the automated storage and retrieval system comprises container handing vehicles moving on the rail system;
   wherein the automated storage and retrieval system comprises a buffer system according to the above or an access station according to the above;
   wherein the container handling vehicles are configured to load a storage container onto the container carrier or unload a storage container from the container carrier being in the container handling position.

In one aspect, the buffer system is located below the rail system.

The present invention also relates to a in one aspect, the buffer system has a width being less than or equal to a width of a storage row of the automated storage and retrieval system.

In one aspect, the width of a storage row is equal to a width of a storage column plus widths of rails on each side of the storage column. The width of a storage column is equal to the width of a storage container.

Hence, only one row of storage columns is occupied by the buffer system. Alternatively, two or three rows of storage columns are occupied by the buffer system.

The present invention also relates to a method for temporarily storing containers in an automated storage and retrieval system, wherein the method comprises the following steps:
moving one of a plurality of container carriers connected to an endless guide to a container handing position;
loading a storage container onto the one container carrier while the one container carrier is in the container handling position;
moving the container carrier along the endless guide to one of a plurality of buffering positions;
moving the other container carriers individually along the endless guide between the container handling position and the buffering positions;
moving the one container carrier to the container handing position again;
unloading the storage container from the one container carrier while the one container carrier is in the container handling position.

In one aspect, the container handling position is located at a height immediately below the rail system. In one aspect, a storage container stored in the container handling position may be stored at a height corresponding to Z=1, i.e. the uppermost layer available for storage containers below the rails 110,111. Hence, container handling vehicles may pass above the storage container stored in the container handling position. It is further achieved that the time used by the container handling vehicle to load a storage container to the container handling position and unload the container from the container handling position is relatively short. In the other storage columns in such automated storage and retrieval systems the storage containers are lifted down onto other storage containers stacked in a stack, where the stack height will vary from stack to stack. In other access stations in such automated storage and retrieval systems, the storage containers are lifted down to a height of ca 1-1.5 meters above ground. Hence, container handling vehicles will be less occupied.

### BRIEF DESCRIPTION OF THE DRAWINGS

Following drawings are appended to facilitate the understanding of the invention. The drawings show embodiments of the invention, which will now be described by way of example only, where:

FIG. 1 is a perspective view of a framework structure of a prior art automated storage and retrieval system.

FIG. 2 is a perspective view of a prior art container handling vehicle having an internally arranged cavity for carrying storage containers therein.

FIG. 3 is a perspective view of a prior art container handling vehicle having a cantilever for carrying storage containers underneath.

FIG. 4 is a perspective view, seen from below, of a prior art container handling vehicle having an internally arranged cavity for carrying storage containers therein.

FIG. 5 is a perspective view of an automated storage and retrieval system comprising a buffer.

FIG. 6 is a side view of the system shown in FIG. 5.

FIG. 7 is a side view of the system shown in FIG. 5 and FIG. 6, wherein one storage container has been removed from one of the carriers.

FIG. 8a is a perspective view from above of a container carrier of the buffer system.

FIG. 8b is perspective view from below of the container carrier of the buffer system.

FIG. 8c is front view of the container carrier of the buffer system.

FIG. 9 is a perspective view of an access station with a buffer system.

FIG. 10 is another perspective view of the access station with buffer in FIG. 10.

FIG. 11 is a side view of the access station with buffer in FIGS. 10 and 11.

FIG. 12 is a simplified illustration of the cross section along line A in FIG. 8c.

FIG. 13 is an alternative embodiment of the embodiment shown in FIG. 12.

FIG. 14 is a side view of an alternative embodiment of the access station.

FIG. 15 is a perspective view of the access station in FIG. 14.

FIG. 16 illustrates a front view of an alternative embodiment of the endless guide and the container carrier.

FIG. 17 illustrates a perspective view from below of the endless guide in FIG. 16.

FIG. 18 illustrates an embodiment where the endless guide has one single guide member.

### DETAILED DESCRIPTION OF THE INVENTION

In the following, embodiments of the invention will be discussed in more detail with reference to the appended drawings. It should be understood, however, that the drawings are not intended to limit the invention to the subject-matter depicted in the drawings.

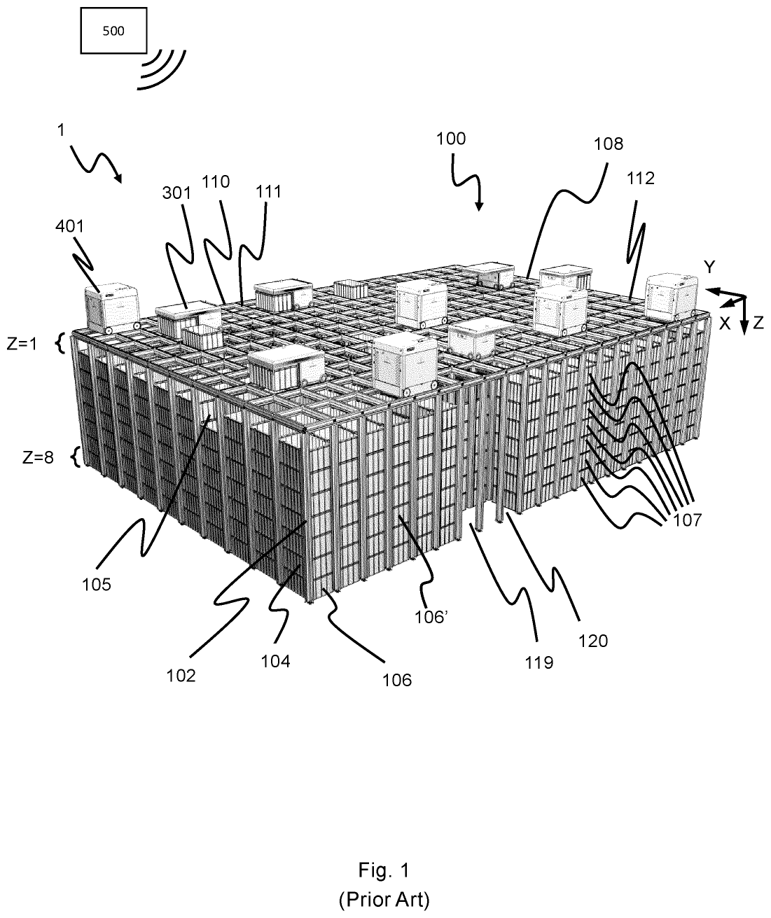

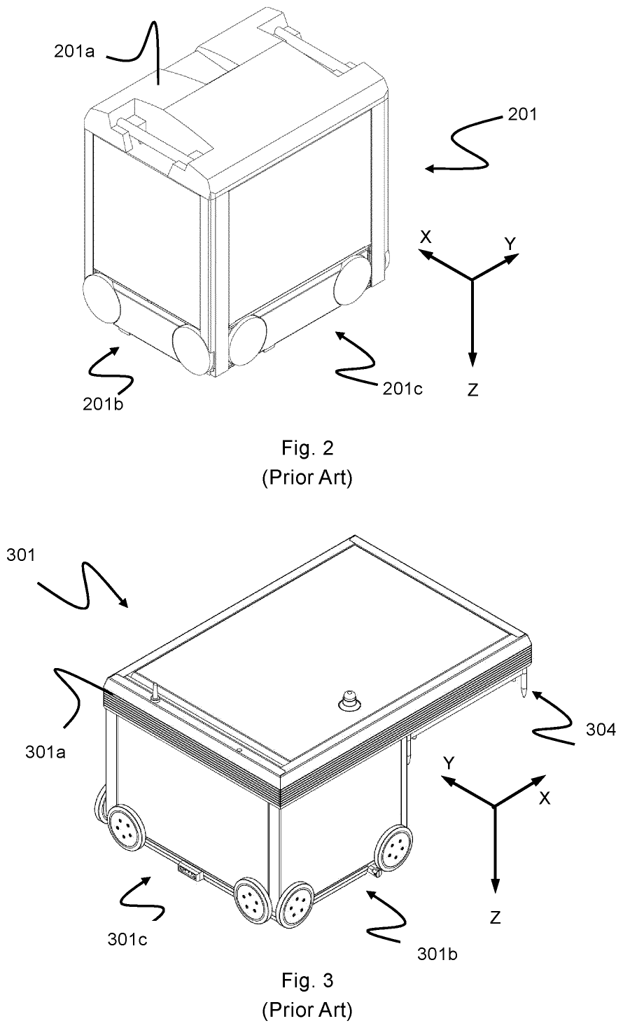

The framework structure 100 of the automated storage and retrieval system 1 is constructed in a similar manner to the prior art framework structure 100 described above in connection with FIGS. 1-3. That is, the framework structure 100 comprises a number of upright members 102, and comprises a first, upper rail system 108 extending in the X direction and Y direction.

The framework structure 100 further comprises storage compartments in the form of storage columns 105 provided between the members 102 wherein storage containers 106 are stackable in stacks 107 within the storage columns 105.

The framework structure 100 can be of any size. In particular it is understood that the framework structure can be considerably wider and/or longer and/or deeper than disclosed in FIG. 1. For example, the framework structure 100 may have a horizontal extent of more than 700×700 columns and a storage depth of more than twelve containers.

### The Buffer System

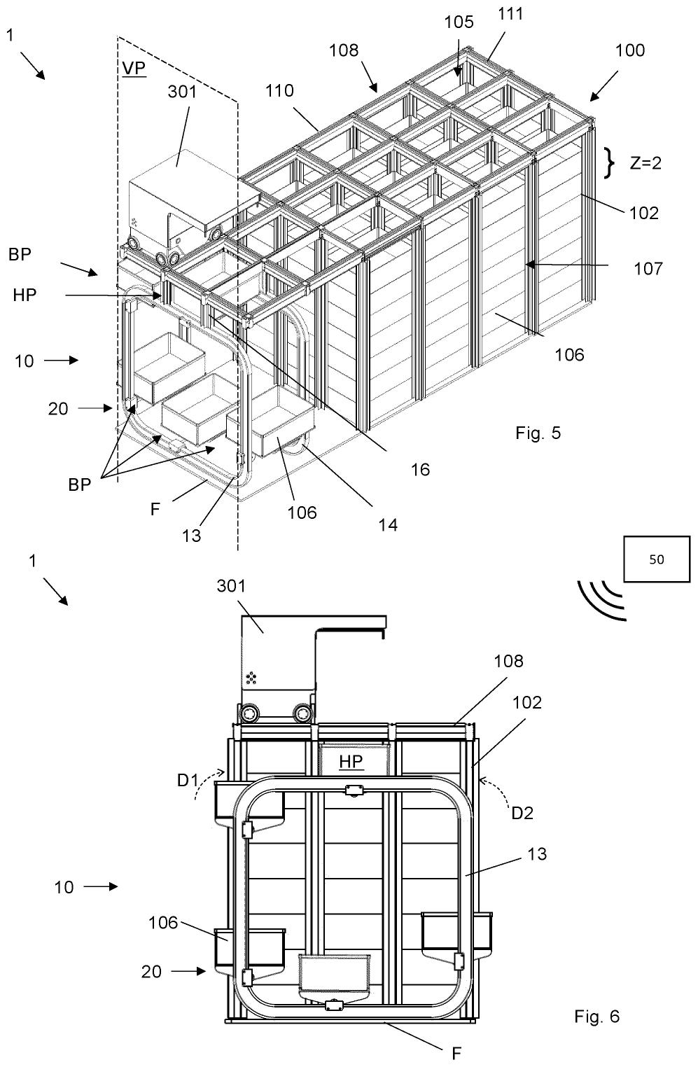

One embodiment of the automated storage and retrieval system 1 according to the invention will now be discussed in more detail with reference to FIGS. 5-8. Here, a relatively smaller framework 100 is shown, with its upright members 102 and rail system 108 with rails 110, 111. One container handling vehicle 301 of the cantilever type is also shown operating on the rail system 108. It should be noted that the framework structure 100 may be a part of a larger framework structure, for example similar to the one shown in FIG. 1.

The automated storage and retrieval system 1 comprises a buffer system 10 for temporarily storing containers 106. The buffer system 10 comprises an endless guide comprising a first guide member 13 and a second guide member 14 spaced apart from the first guide member 13. In FIGS. 5 and 6 it is shown that the first guide member 13 and a second guide member 14 are shaped as a rectangle with rounded corners. The first guide member 13 and a second guide member 14 are both oriented in a vertical plane VP.

In FIG. 5, it is shown that the first guide member 13 and a second guide member 14 are secured to a floor F of the building in which the system 1 is installed. Also the upright members 102 are secured the this floor F. It is further shown that the first guide member 13 and a second guide member 14 are secured to the downwardly facing surface of the rail system 108 by means of vertical elements 16. Hence, the first guide member 13 and a second guide member 14 are supporting the rail system 108 from below, and the rail system 108 together with the floor F are maintaining the orientation of the first guide member 13 and a second guide member 14 in the vertical plane.

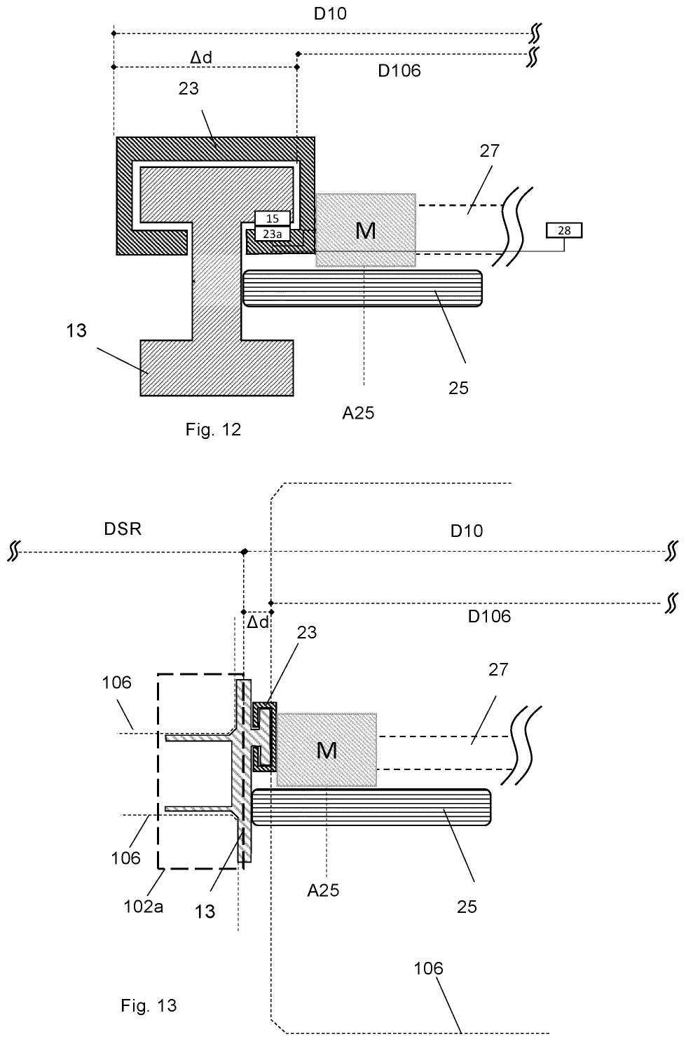

In FIGS. 5-7 and in FIG. 12, it is shown that the first guide member 13 and the second guide member 14 have a T-shaped or H-shaped cross-sectional profile.

The buffer system 10 further comprises a plurality of container carriers 20. Each container carrier 20 is here connected between the first guide member 13 and the second guide member 14.

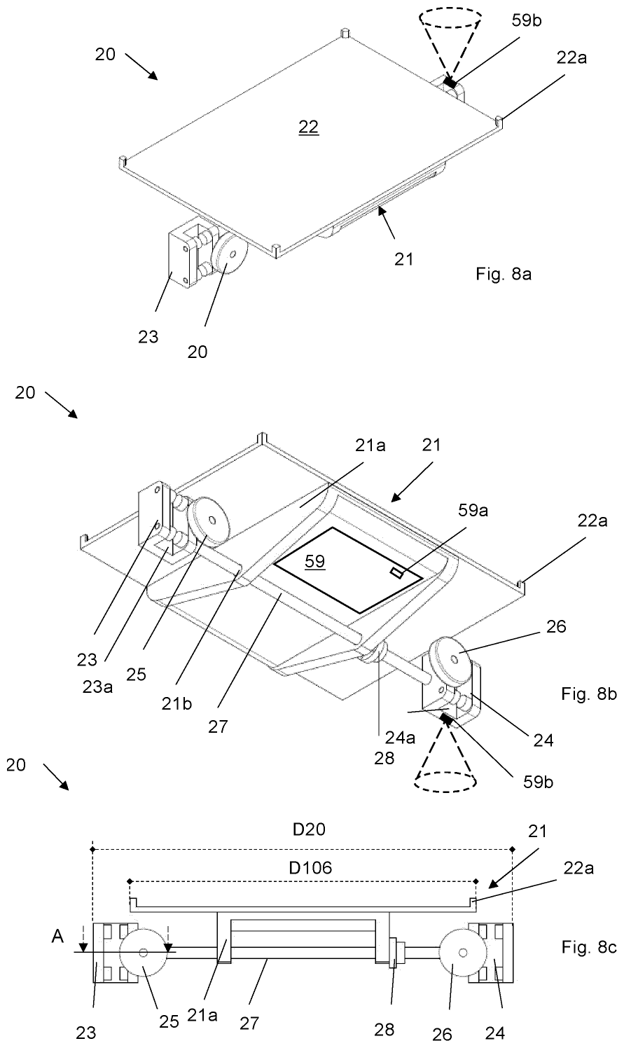

It is now referred to FIGS. 8a, 8b and 8c, where one container carrier 20 is shown in detail.

Here it is shown that the container carrier 20 comprises a main body 21 with a base 21a on which a supporting surface 22 is secured. The supporting surface 22 is configured to receive a storage container 106 and to support the storage container 106 during the movement of the container carrier 20 along the endless guide. The main body 21 is further provided with an aperture 21b through the base 21a.

As shown in FIG. 8a and FIG. 8b, the supporting surface 22 comprises pegs 22a for preventing horizontal movement of the storage container 106 relative to the supporting surface 22. The pegs 22a are here corner pegs protruding upwardly from corners of the supporting surface 22 and is adapted to be received by an recess provided in each corner of the storage container 106.

The container carrier 20 further comprises a first runner 23 and a second runner 24 connected to each other by means of an axle 27. The axle 27 is extending through the opening 21b of the main body 21a. As shown in FIG. 5, FIG. 8a and FIG. 12, the first runner 23 and the second runner 24 are engaged with ends of the T-shaped or H-shaped cross-sectional profile of the respective guide members 13, 14. As shown in FIG. 12, the first runner 23 is engaged with the first guide member 13. Similarly, the second runner 24 is engaged with the second guide member 14. The runners 23, 24 allows the container carrier 20 to run along the endless guide.

The container carrier 20 further comprises a powered wheel 25, 26 for moving the container carrier 20 along the endless guide. As shown in FIG. 12, the wheel 25 is rotated around a rotation axis A25 by means of a motor M. The wheel 25 is provided in contact with the first guide member 13. Hence, when rotated, the wheel 25 will move the carrier 20 relative to the guide member 13. Similarly, the wheel 26 is provided in contact with the second guide member 14 and will move the carrier 20 relative to the guide member 14.

The container carrier 20 further comprises an orientation device 28 connected between the axle 27 and the base 21a for rotating the axle 27 relative to the base 21a. In this way, the supporting surface 22 is oriented with a desired orientation during the movement of the container carrier 20 along the endless guide 13, 14. The orientation device 28 may for example be a servo motor. It should be noted that the container carrier 20 in FIGS. 8a, 8b and 8c are shown in a state in which it is following a vertical section of the endless guide, i.e. the rotation axis of the respective wheels is parallel with the supporting surface 22.

Typically, as shown in FIG. 5, the orientation device 28 is ensuring that the supporting surface 22 is maintained horizontally. However, there may be some situations where the orientation device 28 is controlling the supporting surface 22 to maintain a different orientation than a horizontal orientation.

The container carrier 20 is further comprising a carrier control system 59 configured to control the orientation device 28 and the wheels 25, 26. The carrier control system 59 may comprises a sensor 59a (see FIG. 8b) for sensing the orientation of the supporting surface 22. In addition, the carrier control system 59 may comprise a distance sensor 59b (see FIG. 8a and FIG. 8b) for measuring the distance to an adjacent container carrier 20. In FIG. 8a, the sensor 59b measures the distance to objects above the container carrier 20 (as indicated by the dashed cone), while the sensor 29b in FIG. 8b measures the distance to objects below the container carrier 20 (as indicated by the dashed cone). The sensor 29b may be a proximity sensor, such as an ultrasonic sensor, an IR sensor etc. Preferably, the sensor 29b and/or carrier control system 59 may also be capable of detecting whether the adjacent container carrier 20 is occupied with a storage container or not.

The buffer system 10 may further comprise a control system 50 as indicated in FIG. 6. This control system 50 may be the control system 500 of the automated storage and retrieval system 1 indicated in FIG. 1, or a separate control system 50 provided in communication with the control system 500.

The control system 50 is provided in communication with the carrier control systems 59 of the respective container carriers 20. The control system 50 may be configured to control the movement of the container carriers relative to the endless guide. Hence, the control system 50 may also be configured to prevent collision between two container carriers. However, the carrier control system 59 may also be configured to prevent collision with adjacent container carriers by means of sensors 59b.

The interface between the guide members and the runners may be used to transfer electric energy from a power source to each of the container carriers 20. This is indicated schematically in FIG. 12, where it is shown that the guide member 13 comprises an electrical contact 15 and that the runner 23 comprises an electrical pickup 23a provided in electrical contact with the electrical contact 15 during the movement of the container carrier along the guide member 13. It is also indicated in FIG. 12 that the pickup 23a is electrically connected to the motor M and to the orientation device 28.

It is now referred to FIGS. 5, 6 and 7 again. Here it is shown that the entire buffer system 10 is located below the rail system 108. It should further be noted that the buffer system 10 is defined with a container handling position HP. When a container carrier 20 is in this container handling position HP, a storage container 106 can be loaded onto the supporting surface 22 of the container carrier 20 or a storage container 106 can be unloaded from the supporting surface 22 of the container carrier 20 by means of the container handling vehicle 301.

The buffer system 10 is further defined with buffering positions BP, in which the container carriers 20 may store a storage container 106 on its supporting surface 22. When the carriers 20 are in the buffering positions BP, it is not possible to load/unload a storage container 106 onto/from the supporting surface. Hence, in the embodiment of FIG. 5-7, there is one carrier 20 in the container handling position HP and all the remaining carriers 20 are considered to be in buffering positions BP.

It should be noted that the carriers 20 described above can be moved individually along the endless guide, due to the fact that the wheels of each container carrier 20 can be controlled individually and that there is no moving mechanical link between the container carriers 20 other than the stationary “path” or “road” formed by the endless guide. As shown in FIG. 5, the distance between each of the container carriers are not constant, and it may vary during operation of the buffer system.

It is now referred to FIG. 6. Here it is shown two directions D1 and D2. In the present embodiment, the container carriers 20 are moved in the first direction D1 only. However, in an alternative embodiment, it is possible that the container carriers 20 can be moved in both the first direction D1 and in a second direction D2 opposite of the first direction D1.

It should however be noted that due to the “endless” property of an endless guide, the sequence of container carriers arriving at the container handling position HP will be the same as long as the container carriers are moved in the first direction D1.

While one container carrier 20 is held stationary at the container handling position HP to allow that a container 106 is unloaded from the supporting surface 22 and/or to allow that a container 106 is loaded onto the supporting surface 22, other container carriers 20 may move along the endless guide, as long as collisions between these container carriers are avoided.

The buffer system 10 may comprise a sensor for identifying when a container carrier 20 has arrived at the container handling position HP, for the purpose of stopping the container carrier 20 with its supporting surface correctly aligned below an opening in the rail system 108 through which a storage container can be loaded/unloaded. This sensor may be a single sensor secured to the downwardly facing side of the rail system 108, to the vertical elements 16 or to the endless guide and provided in communication with the carrier control system 59 of the container carrier 20 via the control system 50. Alternatively, one such sensor can be secured to each container carrier 20. The sensor may here be an optical sensor enabling the carrier control system 59 to recognize a visual identifier secured at the container handling position. Alternatively, it may be a mechanical sensor for sensing a protrusion etc. at the container handling position.

A collision is here an impact between two container carriers causing damage to the container carriers, causing damage to the storage containers or the content of the storage containers carried by the container carriers, and/or causing content of the storage containers to fall out from the storage containers. Hence, container carriers 20 may be allowed to carefully move into contact with an adjacent container carrier or a storage container carried by an adjacent container carrier.

It should further be noted that unoccupied container carriers may be stored closer to each other in the vertical sections of the endless guide than occupied container carriers.

It should further be noted that during unloading, the storage container may only be lifted clear of the pegs 22a before the container carrier 20 can begin its movement away from the container handling position HP. Similarly, during loading, the container handling vehicle 301 may start lowering a storage container downwardly while a non-occupied container carrier is moving towards the container handling position HP. Again, the container carrier must arrive at the container handling position HP before the storage container is lowered below the height of the pegs 22a.

It should further be noted that in the present embodiment, the container handling position HP is located at a height immediately below the rail system 108. In the present embodiment, a storage container positioned on the supporting surface of the carrier 20 being in the container handling position HP are approximately at the same height as storage containers stored at height Z=1 in a stack of containers stacked in a storage column, i.e. at the uppermost layer available for storage containers below the rails 110, 111. Container handling vehicles 301 may move along the rail system 108 above the storage container stored in the container handling position HP. Still, the container handling vehicle 301 is lifting/lowering the container 106 a very short vertical distance for every unloading and unloading. When the container handling vehicle 301 is lifting/lowering containers in the storage columns 105, the containers must be moved a short distance sometimes, and a longer distance other times. Consequently, the container handling vehicles will spend less time moving storage containers into and out from the buffer system. In addition, the above operation referred to as digging is not necessary in the buffer system 10.

One obvious disadvantage with the buffer system 10 is the lower storage density of storage containers when compared with the storage columns. However, in some situations faster unloading and loading may be desirable.

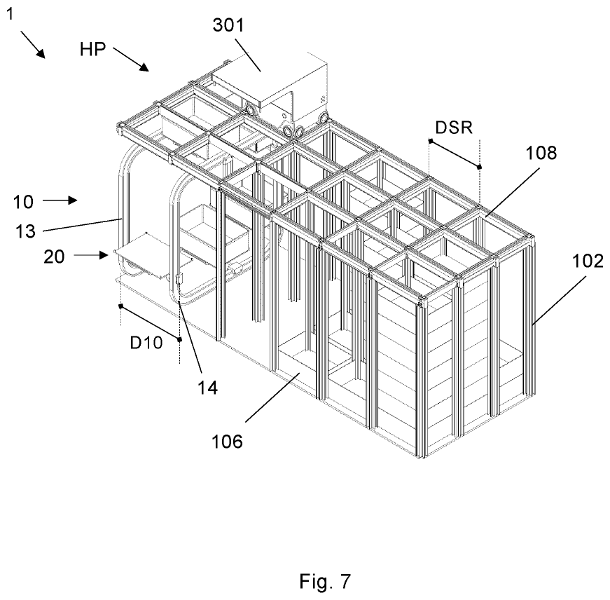

In FIG. 8c, a width D20 of a container carrier 20 is indicated. Also a width D106 of the storage container 106 is indicated here. In FIG. 7, a width D10 of the buffer system 1 is indicated. In FIGS. 5, 6 and 7, the width D10 of the buffer system 10 is larger than a width DSR of a storage row of the automated storage and retrieval system 1. The width DSR is here defined as the distance between the centre axis of two adjacent upright members 102. Of course, as the containers 106 are rectangular, the width D20 of the carrier 20, the width D106 of the container 106, the width D10 of the buffer system 10 and the width DSR of a storage row should be measured in the same direction.

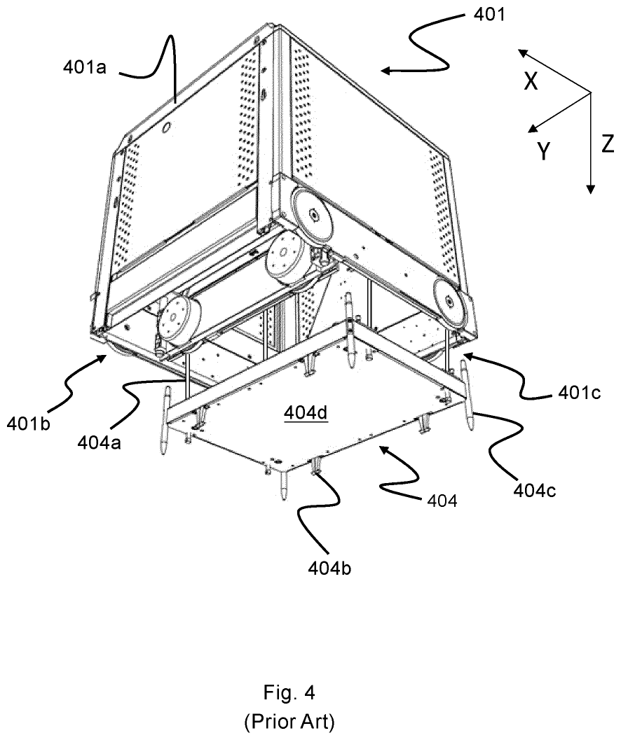

Hence, it is not possible to stack storage containers 106 in stacks adjacent to the buffer system, causing the buffer system to have a footprint width of two storage columns in the case of the buffer system being located in one end of a storage system 1, as shown in FIG. 4. This is caused by the relative large difference between the width D10 of the buffer system and the width D106 indicated as difference Δd in FIG. 12. Of course, the total difference in width will be 2*Δd.

An alternative embodiment is shown in FIG. 13. Here, the difference Δd is much smaller. Moreover, the T-shaped profile of the endless guide 13 is here integrated with, or secured to, a half-section 102a of an upright member 102. As is known from prior art, an upright member 102 is normally guiding corners of four storage containers during their vertical movement up and down the storage columns. The half-section 102a is supporting corners of two storage containers, as indicated by dashed lines 106.

In FIG. 13, parts of the widths DSR, D20 and D106 are also indicated, together with the above smaller distance Δd. In this embodiment, the width D10 of the buffer system 10 is equal to the width DSR of a storage row of the automated storage and retrieval system 1, and hence, storage containers 106 may be stacked adjacent to the buffer system 10. The buffer system here has a footprint width of one storage column.

### The Access Station

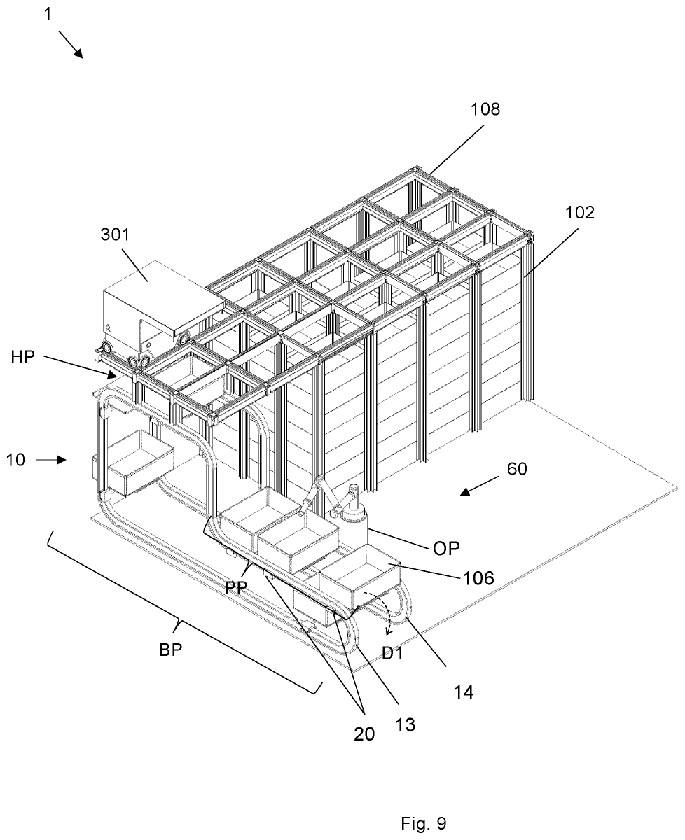

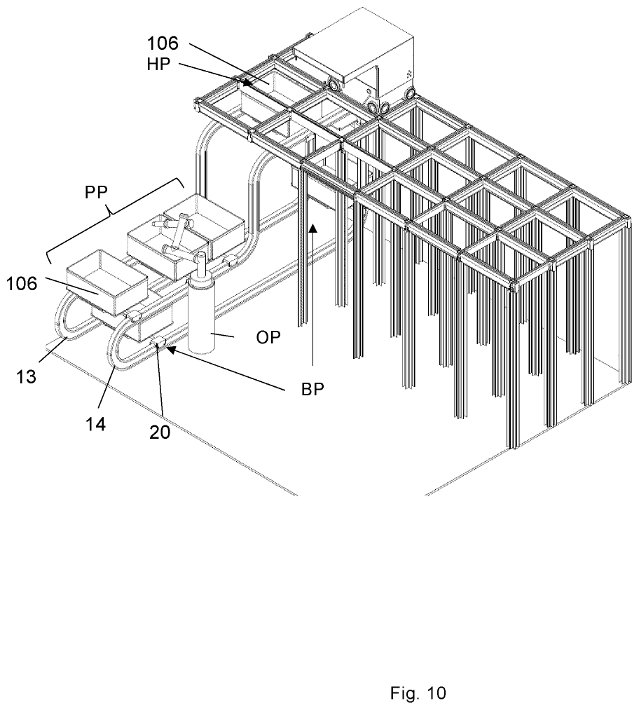

The buffer system 10 described above can also be a part of an access station 60 indicated in FIGS. 9, 10 and 11.

In the access station 60, in addition to the features of the above buffer system 10, i.e. where the above container carriers 20 are moved individually along the endless guide between the container handling position HP and the buffer positions BP, the container carriers 20 are moved to a presentation position PP. At this presentation position PP, the storage container 106 stored on the container carrier 20 is presented to an operator OP. In the drawings, the operator OP is illustrated as a picking robot. However, the operator may also be a person performing a picking operation or a replenishment operation.

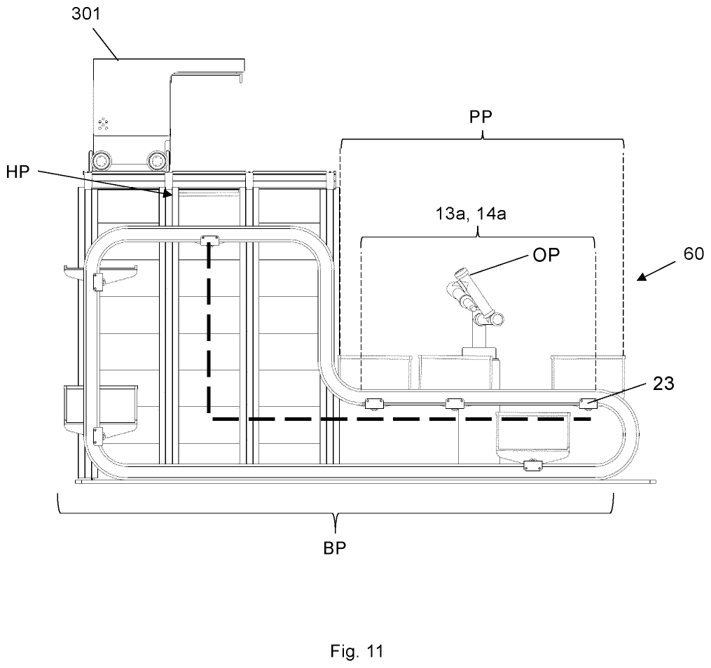

In FIG. 9, up to three container carriers 20 can be in the presentation position PP at the same time, allowing the operator OP to pick from all three containers 106 carried by the three container carriers 20 at the same time. It should further be noted that in FIG. 9, the rightmost container carrier 20 may start its movement in the first direction D1 away from the presentation position PP while the other two container carriers in the presentation position PP can be held stationary or can be moved slowly in the first direction D1 while allowing the operator OP to pick from the storage containers while they move. Hence, even though the term position is used, this does not necessarily imply that the container carriers are held stationary in this position. In FIG. 11, the container carriers 20 are considered to be in the presentation position PP as long as the runners 23, 24 are in contact with sections 13a, 14a of the endless guide. An exemption here is the container handling position, where the container carrier should be held stationary for a short moment to allow proper alignment of the container on the supporting surface 22 between the pegs 22a.

In FIG. 11, it is shown that the endless guide 13, 14 here is substantially L-shaped, as indicated by the dashed line, wherein the container handling position HP is located in an upper part of a vertical projection of the L-shaped endless guide 13, 14 and the presentation position PP is located along a horizontal projection of the L-shaped endless guide 13, 14.

### Alternative Embodiments

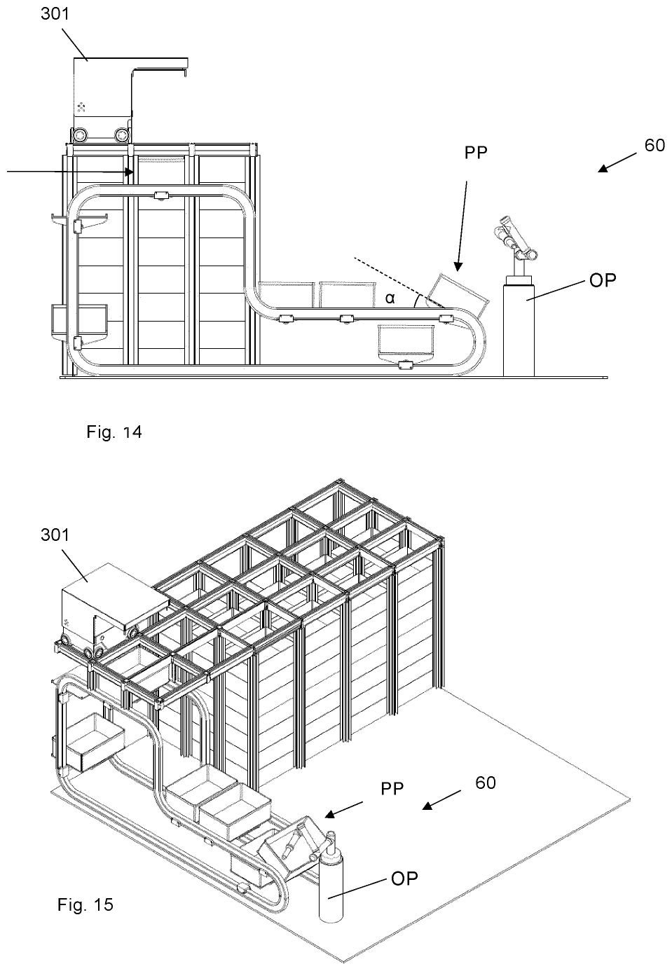

It is now referred to FIGS. 14 and 15. Here, there is one presentation position PP. When the carrier 20 is in this presentation position, the carrier control system 59 of that carrier 20 is configured to control its associated orientation device 28 to keep the supporting surface 22 in an inclined orientation relative to the horizontal plane, as indicated with the angle α. In this inclined position, it may be easier for the operator to perform picking and/or replenishment. The inclination α may be ca 150-45° relative to the horizontal plane.

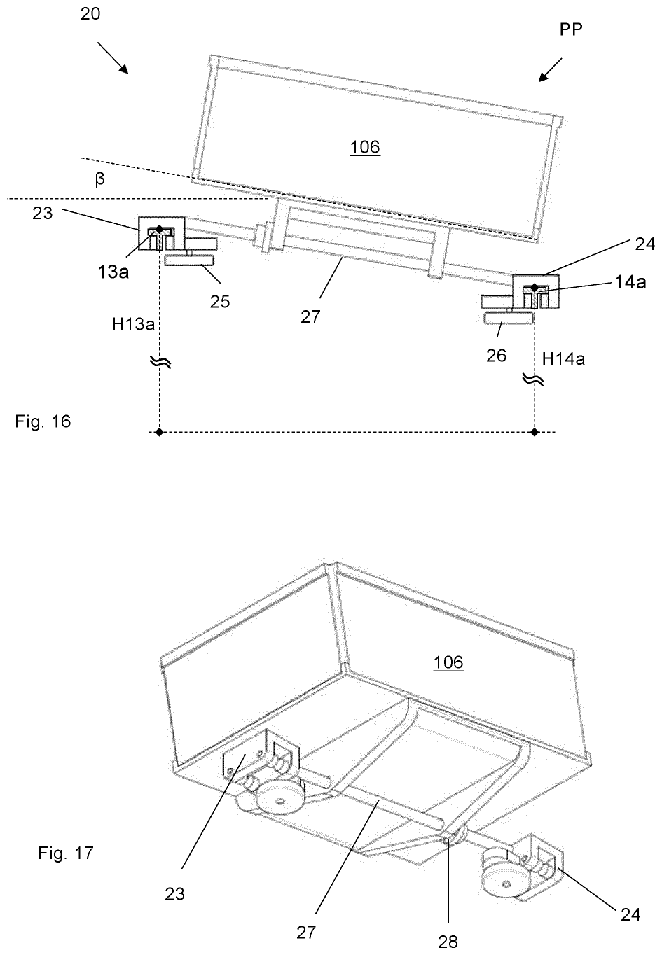

It is now referred to FIGS. 16 and 17. Here it is shown that the section 13a (indicated in FIG. 11) of the first guide member 13 is located at a first height H13a and that a section 14a (also indicated in FIG. 11) of the second guide member 14 is located at a second height H14a. The first height H13a is larger than the second height H14a. Hence, it is achieved that the supporting surface 22, and hence the storage container supported on the supporting surface 22, becomes inclined with an angle β with respect to the horizontal plane. Also this inclination β may be ca 15°-45° relative to the horizontal plane. In this embodiment, the axle 27 is pivotably connected to the first runner 23 and the second runner 24.

In yet one alternative embodiment, the powered wheel 25, 26 is used also for the purpose of connecting the main body 21 to the endless guide 13, 14. Hence, the runners are not essential.

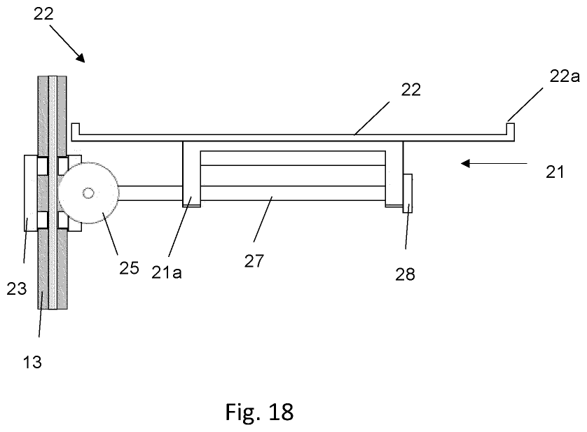

It is now referred to FIG. 18. Here it is shown an embodiment of the container carrier 20 has only one runner 23 and only one powered wheel 25. In this embodiment, the endless guide comprises only one guide member 13. This embodiment is particularly suitable if the weight of the content of the storage container 106 is relatively smaller.

In the preceding description, various aspects of the buffer system, the access station and the automated storage and retrieval system according to the invention have been described with reference to the illustrative embodiment. For purposes of explanation, specific numbers, systems and configurations were set forth in order to provide a thorough understanding of the system and its workings. However, this description is not intended to be construed in a limiting sense. Various modifications and variations of the illustrative embodiment, as well as other embodiments of the system, which are apparent to persons skilled in the art to which the disclosed subject matter pertains, are deemed to lie within the scope of the present invention.

### LIST OF REFERENCE NUMBERS

1 automated storage and retrieval system
10 buffer system
13 first guide member of endless guide
13a section of first guide member
14 second guide member of endless guide
14a section of second guide member
15 electrical contact
16 vertical elements
20 container carrier
21 main body
21a base
21b aperture
22 supporting surface
22a pegs
23 first runner
23a electrical pickup
24 second runner
24a electrical pickup
25 powered wheel
26 powered wheel
27 axle
28 orientation device
29b sensor
50 control system
59 carrier control system
59s sensor
59b sensor
60 access station
102 upright members
102a half-section of upright member
A25 rotation axis
BP buffering positions
D1 first direction
D2 second direction
H13a first height
H14a second height
HP container handling position
OP operator
PP presentation position
VP vertical plane
Δd difference
α angle of inclination
β angle of inclination
100 Framework structure
102 Upright members of framework structure
104 Storage grid
105 Storage column
106 Storage container
106′ Particular position of storage container
107 Stack
108 Rail system
110 Parallel rails in first direction (X)
112 Access opening
119 First port column
120 Second port column
201 Prior art container handling vehicle
201a Vehicle body of the container handling vehicle 201
201b Drive means/wheel arrangement/first set of wheels in first direction (X)
201c Drive means/wheel arrangement/second set of wheels in second direction (Y)
301 Prior art cantilever container handling vehicle
301a Vehicle body of the container handling vehicle 301
301b Drive means/first set of wheels in first direction (X)
301c Drive means/second set of wheels in second direction (Y)
304 Gripping device
401 Prior art container handling vehicle
401a Vehicle body of the container handling vehicle 401
401b Drive means/first set of wheels in first direction (X)
401c Drive means/second set of wheels in second direction (Y)
404 Gripping device
404a Lifting band
404b Gripper
404c Guide pin
404d Lifting frame
500 Control system
X First direction
Y Second direction
Z Third direction

1.-24. (canceled)

25. A buffer system for temporarily storing containers in an automated storage and retrieval system, wherein the buffer system comprises:
an endless guide; and
a plurality of container carriers connected to the endless guide, wherein the plurality of container carriers are individually movable along the endless guide between a container handling position, in which a container is loaded onto and/or unloaded from one of the container carriers, and buffering positions, in which the containers are temporarily stored on their respective container carrier.

26. The buffer system according to claim 25, wherein the endless guide is oriented in a vertical plane.

27. The buffer system according to claim 25, wherein the endless guide comprises a first guide member and a second guide member spaced apart from the first guide member, wherein the plurality of container carriers are connected between the first guide member and the second guide member.

28. The buffer system according to claim 25, wherein each of the plurality of container carriers comprises:
a main body comprising a supporting surface for supporting a storage container;
a powered wheel for moving the main body along the endless guide; and
an orientation device for orienting the supporting surface during movement of the container carrier along the endless guide.

29. The buffer system according to claim 28, wherein each of the plurality of container carriers comprises a carrier control system for controlling the orientation device and the powered wheel.

30. The buffer system according to claim 28, wherein each of the plurality of container carriers comprises a runner for connecting the main body to the endless guide.

31. The buffer system according to claim 30, wherein the endless guide comprises an electrical contact; wherein the runner comprises an electrical pickup provided in electrical contact with the electrical contact, wherein the powered wheels and/or the orientation device are supplied with electrical power via the electrical pickup and the electrical contact.

32. The buffer system according to claim 29, wherein the carrier control system of each container carrier is configured to control its associated orientation device to keep the supporting surface in a horizontal orientation during movement of the container carrier around the endless guide.

33. The buffer system according to claim 28, wherein each of the plurality of container carriers comprises:
an axle extending between a first runner and a second runner, wherein the supporting surface is arranged to pivot around the axle by means of the orientation device.

34. The buffer system according to claim 33, wherein the main body comprises a base on which the supporting surface is provided; wherein the axle is extending through an opening provided in the base.

35. The buffer system according to claim 28, wherein the supporting surface comprises pegs for preventing horizontal movement of the storage container relative to the supporting surface.

36. The buffer system according to claim 28, wherein the buffer system has a width being less than or equal to a width of a storage row of the automated storage and retrieval system.

37. The buffer system according to claim 29, wherein the buffer system comprises:
a control system provided in communication with the carrier control systems of the respective container carriers, wherein the control system is configured to prevent collision between the container carriers.

38. The buffer system according to claim 29, wherein the carrier control system is configured to stop the movement of the container carrier at the container handling position while moving other container carriers along the endless guide.

39. An access station for presentation of a storage container from the automated storage and retrieval system to an operator at the access station, wherein the access station comprises:
the buffer system according to claim 25;
wherein the plurality of container carriers are individually movable along the endless guide to a presentation position, in which one of the storage containers stored on its respective container carrier is presented to the operator.

40. The access station according to claim 39, wherein the endless guide is substantially L-shaped, wherein the container handling position is located in an upper part of a vertical projection of the L-shaped endless guide and the presentation position is located along a horizontal projection of the L-shaped endless guide.

41. The access station according to claim 39, wherein a carrier control system of each container carrier is configured to control its associated orientation device to keep a supporting surface in an inclined orientation relative to a horizontal plane in the presentation position.

42. The access station according to claim 39, wherein the endless guide comprises a first guide member and a second guide member, wherein a section of the first guide member is located at a first height, wherein a section of the second guide member is located at a second height, wherein the container carriers moving along the sections are in their presentation position and wherein the first height is larger than the second height.

43. The access station according to claim 42, wherein an axle is pivotably connected to a first runner and a second runner.

44. The access station according to claim 39, wherein the access station comprises more than one presentation position.

45. The automated storage and retrieval system comprising a framework structure, wherein the framework structure comprises:
upright members;
a storage volume comprising storage columns provided between the upright members, wherein storage containers are stackable in stacks within the storage columns; and
a rail system provided on top of the upright members;
wherein the automated storage and retrieval system comprises container handling vehicles moving on the rail system;
wherein the automated storage and retrieval system comprises the buffer system according to claim 25 or an access station according to claim 39;
wherein the container handling vehicles are configured to load a storage container onto the container carrier or unload a storage container from the container carrier being in the container handling position.

46. The automated storage and retrieval system according to claim 45, wherein the buffer system is located below the rail system.

47. The automated storage and retrieval system according to claim 45, wherein the buffer system has a width being less than or equal to a width of a storage row of the automated storage and retrieval system.

48. A method for temporarily storing containers in an automated storage and retrieval system, wherein the method comprises following steps:
moving one of a plurality of container carriers connected to an endless guide to a container handling position;
loading a storage container onto the one container carrier while the one container carrier is in the container handling position;
moving the container carrier along the endless guide to one of a plurality of buffering positions;
moving other container carriers individually along the endless guide between the container handling position and the buffering positions;
moving the one container carrier to the container handling position again; and
unloading the storage container from the one container carrier while the one container carrier is in the container handling position.
